(19) United States
(12) Patent Application Publication
(10) Pub. No.: US 2020/0309222 A1
(43) Pub. Date: Oct. 1, 2020

(54) FRICTION LINING, PROCESS FOR ITS MANUFACTURE AND ITS USE

(71) Applicant: TMD Friction Services GmbH, Leverkusen (DE)

(72) Inventors: Georg MÜLLER, Koln (DE); Enrique WEGMANN, Leichlingen (DE)

(73) Assignee: TMD Friction Services GmbH, Leverkusen (DE)

(21) Appl. No.: 16/816,803

(22) Filed: Mar. 12, 2020

(30) Foreign Application Priority Data
Mar. 27, 2019 (DE) 102019107915.2

(51) Int. Cl. F16D 69/02

(52) U.S. Cl. CPC F16D 69/027; F16D 2200/0086; F16D 2200/003

(57) ABSTRACT

Aluminum alloys, in particular Al magnesium or Al titanium alloys, are suitable as corrosion protection media in friction linings for automotive brakes and couplings, and serve as a replacement for zinc metal or zinc compounds in such linings.

### BACKGROUND OF THE INVENTION

### Technical Field and State of the Art

The invention relates to a friction lining or friction lining mixture preferably suitable for use in brake pads or couplings. Furthermore, the invention relates to methods for producing such friction linings, as well as brakes, brake pads, couplings, and coupling pads with such friction linings.

Common friction lining mixtures generally have the following compositions:
Metals (fibers and powders, mostly iron-containing),
Fillers,
Lubricant (solid lubricants), and
Organic components such as resins, rubbers, or organic fibers and fillers.

The metal shares of the friction linings generally comprise zinc or zinc alloys, which serve mainly as a corrosion protection and, for example, are meant to prevent the occurrence of rust in the steel and cast components of the brakes and couplings, in particular in the iron-containing friction partners, such as brake discs and brake drums, and in the iron-containing components of the friction lining mixture.

However, the use of zinc in friction lining mixtures is increasingly viewed with criticism. Zinc is classified as a heavy metal, and an increase in the zinc concentration in the environment should be kept as low as possible from health and ecological standpoints.

With respect to the corrosion protection of brake systems even without the use of zinc, very different solutions have already been proposed in the prior art.

EP 2 778 462 A1 describes a galvanic contact of the brake, wherein the applied voltage is selected such that no corrosion occurs.

EP 3 327 099 A1 proposes a friction lining with an alkaline pH value, whereby oxidation reactions are meant to be suppressed.

From EP 0 079 732 A1, it is known to avoid the occurrence of rust in and on the steel and cast components of brakes and couplings by lining the friction material with a metal. This metal forms a metal surface that is less precious relative to steel and consists of a zinc, aluminum, or magnesium alloy. However, this method only prevents rusting during transport of the vehicles equipped in such a way, because this thin protective layer is removed after just a few actuations of brakes or couplings.

EP 1 097 313 B1 provides for the use of an aluminum zinc alloy as a corrosion protection in friction linings.

However, the use of such alloys may be associated with various disadvantages. Thus, the addition of AlZn₅ in some friction lining mixtures can lead to the formation of foam and aluminum oxide flakes on the surface of the lining. It has furthermore been found that the friction lining can swell, depending upon the AlZn₅ concentration. Finally, the production of AlZn₅ is relatively complex and is classified as an environmental burden due to its zinc content, which in turn has effects on the corresponding waste disposal.

The objective of the present invention is thus the provision of friction linings or friction lining mixtures in which the use of zinc, zinc compounds, or zinc alloys can be omitted completely or at least insofar as possible.

### SUMMARY OF THE INVENTION

This objective according to the invention is solved, in principle, by omitting the use of zinc and using as a zinc replacement an alloy that is less reactive than, e.g., AlZn₅ or another zinc alloy, but still provides sufficient corrosion protection. It has been found that the problems associated with the use of a zinc alloy, such as AlZn₅, are primarily attributable to the high chemical reactivity of these substances.

The friction lining mixtures according to the invention therefore preferably have reactivities between those of a Zn metal-containing and an AlZn₅-containing friction lining mixture or the friction lining produced from it (these friction lining mixtures/linings being otherwise identical in composition).

### DETAILED DESCRIPTION OF THE INVENTION

To determine the suitability of a Zn-free alloy as a corrosion protection in otherwise typical or customary friction linings (with respect to the qualitative and quantitative composition), various alloys are mixed into a typical friction mixture containing no zinc or containing a zinc alloy and then pressed into friction linings or test specimens. The corresponding Zn powder-containing and AlZn₅-containing friction linings are then used as reference mixtures.

The tests used within the scope of the present invention are preferably:
1. Storage of the friction linings or sample specimens for 14 days at room temperature in a 5% by weight NaCl solution,
2. Voltammetry test: Determination of the redox potential/redox voltage E^{o} according to DIN38404-6, and
3. Galvanometry test: Determination of the electrical load density.

These tests are known to a person skilled in the art and are described, for example, in DIN Standard 50918 Corrosion of Metals.

The evaluation of the first test occurs visually, gravimetrically, and by a dimensioning of the test specimen. It is checked (visually) whether rust formation is detectable on the test specimens, and a color determination is also performed for the NaCl solution. In the voltammetry test, it is determined whether the friction lining according to the invention has at least one negative redox potential (Eₒ) between a Zn-containing and AlZn₅-containing reference mixture. For the determination of the load density (galvanometry test), a value should be achieved that is at least exactly as high as the Zn-containing reference mixture. In the tests described, the share of Zn metal or Zn alloy in the reference mixtures corresponds to the share of non-Zn-containing alloys in the mixtures according to the invention (expressed in each case as % by weight of the finished friction lining).

Aluminum alloys with magnesium (Mg) or titanium (Ti) have proven to be particularly suitable for solving the present objective. Other alloy partners, such as silicon (Si), are basically suitable. These can be binary, ternary, or quaternary alloy systems, of which the binary aluminum alloys are particularly preferred. These binary systems of the type AlₓZ_{y} (with Z preferably equal to Mg and Ti and x=10-90% by weight and y=10-90% by weight) have proven to be particularly suitable with respect to electrode or redox potential (=reactivity), shape stability, and load density. Alloys such as AlTi₁₀ and AlMg₅₀ are mentioned here, in particular.

The alloys according to the invention contain one or more of the following metals Mg, Ti, Si, Ba, Sr, Ca, Be, Zr, Cr, Fe, Sn, Bi, and aluminum. The friction lining mixtures according to the invention can also contain powder of a metal mixture from the specified components. The alloys are produced by melting and homogenizing the components into a finely dispersed system. A variety of such alloys are commercially available.

The share of alloys according to the invention in the friction lining mixture or the finished friction lining can be preferably between 0.5-15% by weight. These alloys can be used in all customary friction linings in which Zn or Zn alloys are used according to the prior art. A special adjustment of the remaining components of the friction lining to the alloys described here is therefore not required. In the mixtures of the prior art, only the Zn or Zn alloy components are preferably replaced by the alloys according to the invention. As a rule, the replacement can also occur 1:1 with respect to the respective weight percentage of the friction lining, or with small deviations.

The provision of a metal that is less precious relative to iron or steel in the friction material mixture prevents the rusting of the friction partner made of steel or iron. The aluminum alloy components in the friction lining form a sacrificial anode, so that a rusting and, in particular, a corroding of the friction partner on the friction lining can be reliably avoided. It is advantageous that the sacrificial anode can always be renewed with the wearing of the friction lining.

The effectiveness of corrosion-inhibiting particles depends on whether their distribution takes place evenly over the cross section of the friction linings. This is achieved in a particularly convenient manner with an alloy according to the invention, which is preferably added in powder form.

An additional advantage can be achieved with the alloys according to the invention if they are introduced into the friction lining in powder form. The addition in powder form reduces the adhesion of iron and steel parts to the friction linings of brakes and couplings that occurs under certain ambient conditions and thus reduces the so-called “bonding corrosion.”

The alloys according to the invention are preferably introduced into the friction material mixture in particle form. As a lubricant, tin sulfides with a weight percentage between approx. 0.5 to 10% by weight, preferably approx. 2 to 8% by weight, can be contained.

To produce the friction lining, it is provided that the aluminum alloys, preferably present in strand or block form, are first rinsed and then sprayed in order to produce essentially spherical particles. These particles are then mixed with a typical friction material mixture and pressed into a friction lining at known temperatures and pressures.

However, powder particles can also be formed directly from the melting of the alloy, e.g., by spraying or spinning over the edge of a rotating disc. The particle size of the alloys according to the invention is preferably in the range of 100 μm and 700 μm. Aluminum alloys with other metals, such as Al/Mg alloys, are also commercially available in particle form.

As fillers for friction linings according to the invention, metal oxides, metal silicates, and/or metal sulfates can be contained individually or in combination with other fillers. The fibrous substances preferably consist of aramid fibers and/or other organic or inorganic fibers. Other than the aluminum alloy, steel wool and/or copper wool can be contained as metals, for example.

Tin sulfides with a weight percentage of 0.5 to 10% by weight, preferably 2 to 8% by weight, are preferably used as lubricants. For example, the tin sulfides can be attached as a powder of the friction lining mixture.

The alloys according to the invention can be used in any friction lining mixture, in principle. The production of the friction linings according to the invention can occur according to conventional methods as well as those known from the prior art, i.e., by mixing all starting components and pressing the friction lining mixture obtained in this way at increased pressure and increased temperature. In the typical application, the Al alloy serving as the corrosion protection is placed as a powder into a mixer along with the remaining mixture components, whereby the alloy particles are homogeneously distributed in the friction material during the mixing process. This further means that, when using a corresponding brake pad, new corrosion protection material is constantly reaching the friction lining surface due to the friction process. As a result, uniform or constant conditions always prevail on the surface of the friction lining during the application cycle.

### EXAMPLE

A friction material mixture according to the invention can, for example, be composed as follows, wherein all weight % information is based upon the finished friction material mixture from which the actual friction lining is produced:

| Raw materials | % by weight |
|---|---|
| Steel wool | 15-25 |
| Copper and/or copper alloys | 3-20 |
| Aluminum Mg/Ti alloy | 0.5-15 |
| Aluminum oxide | 0.5-2 |
| Mica powder | 5-8 |
| Baryte | 5-15 |
| Iron oxide | 5-15 |
| Tin sulfides | 2-8 |
| Graphite | 2-6 |
| Coke powder | 10-20 |
| Aramid fiber | 1-2 |
| Resin filler powder | 2-6 |
| Binding resin | 3-7 |

The present invention thus relates to the use of the Al alloys according to the invention as a corrosion protection (medium) and/or as a replacement for zinc metal and/or zinc compounds in friction linings and corresponding friction lining mixtures. Furthermore, these friction linings and friction lining mixtures include brake pads and couplings having compositions or friction linings according to the invention, as well as methods for producing the materials named.

Additional objectives, advantages, features and application possibilities of the present invention can be gleaned from the description herein of embodiments. In this context, all of the described features, either on their own or in any meaningful combination, constitute the subject matter of the present invention, also irrespective of their compilation in the claims or in the claims to which they refer back.

1. A friction lining for a motor vehicle, comprising:
a friction lining mixture that contains an aluminum alloy of one or more of the following metals selected from the group consisting of: magnesium (Mg), titanium (Ti), silicon (Si), barium (Ba), strontium (Sr), calcium (Ca), beryllium (Be), zirconium (Zr), chromium (Cr), iron (Fe), tin (Sn), and bismuth (Bi), wherein said friction lining mixture is free of zinc metal, zinc alloys, and zinc compounds.

2. The friction lining of claim 1, in which the aluminum alloy is an alloy of the formula AlₓZ_{y}, wherein Z is selected from one of magnesium (Mg), titanium (Ti) or silicon (Si), and x and y each represent ranges from 10% through 90% by weight.

3. The friction lining of claim 1, wherein the aluminum alloy is a binary Al—Mg alloy or an Al—Ti alloy.

4. The friction lining of claim 2, wherein the aluminum alloy is a ternary or quaternary alloy containing magnesium (Mg) and/or titanium (Ti) and/or silicon (Si), and in which y stands for the sum of the shares of the component Z.

5. The friction lining of claim 1, wherein the aluminum alloy is AlTi₁₀ or AlMg₅₀.

6. The friction lining of claim 1, wherein the aluminum alloy is added to the friction lining mixture in particle form.

7. The friction lining of claim 6, wherein the aluminum alloy particles have a particle size in the range of from 100 μm to 700 μm.

8. The friction lining of claim 1, wherein the aluminum alloy is present in an amount from 0.5% by weight to 15% by weight of the friction lining material.

9. A method for producing a friction lining for a motor vehicle, comprising:
preparing a friction lining mixture that contains an aluminum alloy of one or more of the following metals selected from the group consisting of: magnesium (Mg), titanium (Ti), silicon (Si), barium (Ba), strontium (Sr), calcium (Ca), beryllium (Be), zirconium (Zr), chromium (Cr), iron (Fe), tin (Sn), and bismuth (Bi), wherein said friction lining mixture is free of zinc metal, zinc alloys, and zinc compounds; and
pressing the friction lining mixture into a heated mold.

10. The method of claim 9, wherein the aluminum alloy is added to the friction lining mixture in particle form.

11. The method of claim 10, wherein the aluminum alloy particles have a particle size in the range of from 100 μm to 700 μm.

12. The method of claim 9, wherein the aluminum alloy is present in an amount from 0.5% by weight to 15% by weight of the friction lining material.

13. The method of claim 9, wherein the aluminum alloy is a binary Al—Mg alloy or an Al—Ti alloy.
